(19) United States
(12) Patent Application Publication
(10) Pub. No.: US 2021/0346917 A1
(43) Pub. Date: Nov. 11, 2021

(54) Self-cleaning Device and Cleaning Method for Highway Tunnel Retro-reflective Arch

(71) Applicant: Fuzhou University, Fuzhou City (CN)

(72) Inventors: Yanqun Yang, Fuzhou City (CN); Jingqiu Cao, Fuzhou City (CN)

(21) Appl. No.: 17/357,189

(22) Filed: Jun. 24, 2021

Related U.S. Application Data
(63) Continuation of application No. PCT/CN2020/136638, filed on Dec. 16, 2020.

(30) Foreign Application Priority Data
Dec. 23, 2019 (CN) 2019113329895

(51) Int. Cl. B08B 1/00; B08B 13/00; B08B 3/04; B08B 5/04

(52) U.S. Cl. CPC B08B 1/002; B08B 5/04; B08B 3/04; B08B 13/00

(57) ABSTRACT

The invention relates to a self-cleaning device for a highway tunnel retro-reflective arch, wherein a middle framework sucking disc arm, an upper sucking disc and a lower sucking disc are arranged inside an end framework sucking disc arm; the end framework sucking disc arm and the middle framework sucking disc arm are driven by an electric mechanism to relatively move in the width direction of the tunnel; and the middle framework sucking disc arm is equipped with a wiping brush, a cleaning brush and a cleaning liquid box in which a liquid spray pump is arranged. In use, the self-cleaning device for the highway tunnel retro-reflective arch wipes the retro-reflective arch in a self-traveling process on the top wall of the tunnel and the side walls of the retro-reflective arch.

### CROSS REFERENCE TO RELATED APPLICATION

The invention relates to a self-cleaning device and a cleaning method for a highway tunnel retro-reflective arch.

### BACKGROUND OF THE INVENTION

At present, with the development of highway construction in China, the number and length of tunnels are increasing, and retro-reflective arch plates in the tunnels are polluted by various factors such as automobile tail gas, which greatly reduce the effect of the retro-reflective arch plates.

At present stage, the cleaning work of the retro-reflective arch plates adopts the original manual method for cleaning, which has a major impact on traffic safety and the consumption of manpower and material resources.

Based on this, it is necessary to design a self-cleaning device for automatically walking and cleaning the retro-reflective arch.

### SUMMARY OF THE INVENTION

In view of the deficiencies of the prior art, the technical problem to be solved by the invention is to provide a self-cleaning device and a cleaning method for a highway tunnel retro-reflective arch, which is not only simple in structure, but also convenient and efficient.

To solve the technical problem, the invention adopts the following technical solution: A self-cleaning device for a highway tunnel retro-reflective arch includes an end framework sucking disc arm, where a middle framework sucking disc arm is arranged in the end framework sucking disc arm; upper sucking discs used for adsorbing the top wall of the tunnel upwards and lower sucking discs used for adsorbing the side wall of the retro-reflective arch forwards or backwards are separately arranged on the end framework sucking disc arm and the middle framework sucking disc arm; the end framework sucking disc arm and the middle framework sucking disc arm are driven by an electric mechanism to relatively move in the width direction of the tunnel;

a wiping brush and a cleaning brush are arranged on the side of the lower sucking disc of the middle framework sucking disc arm in sequence in the moving direction, and the wiping brush and the cleaning brush are connected to the middle framework sucking disc arm through connecting rods; a cleaning liquid box is arranged on the middle framework sucking disc arm and is in communication through a cleaning liquid tube to spray liquid to the cleaning brush, and a liquid spray pump is arranged in the cleaning liquid box.

Preferably, the electric mechanism includes a main gear girder which is fixedly arranged on the end framework sucking disc arm and extends in the width direction of tunnel, where the lower side surface of the main gear girder is provided with a rack and the other three side surfaces are provided with wheel slots.

Preferably, a fixed auxiliary frame sleeves the periphery of the main gear girder, the lower side part of the fixed auxiliary frame is equipped with a gear engaged with the rack, and the other three side parts are equipped with pressure wheels which are embedded into the corresponding wheel slots to roll.

Preferably, a fixed main frame is fixedly connected below the fixed auxiliary frame, a motor with an output shaft connected to a gear is mounted on the fixed main frame, and the fixed main frame is connected to the middle framework sucking disc arm.

Preferably, the top of the tunnel and the retro-reflective arch are arc-shaped. Preferably, a first rotary shaft extending in the horizontal direction is fixedly arranged on the fixed main frame, the middle part of the middle framework sucking disc arm is fixedly equipped with a second rotary shaft extending in the horizontal direction, and the first rotary shaft is coaxially inserted into the second rotary shaft to relatively rotate.

Preferably, a torsion spring coaxially sleeves the peripheral part of the first rotary shaft and the peripheral part of the second rotary shaft, one end of the torsion spring is fixed to the first rotary shaft and the other end of the torsion spring is fixed to the second rotary shaft.

Preferably, vacuum generators are connected on the upper sucking disc and the lower sucking disc, an equal-length motor touch switch lever, a sucking disc touch switch lever of an end framework and a sucking disc touch switch lever of a middle framework, which extend in the width direction of the tunnel, are arranged on the end framework sucking disc arm; the two ends of the end framework sucking disc arm are used for touching the end framework sucking disc arm while the end framework sucking disc arm and the middle framework sucking disc arm relatively move; a contact point which is in touch conduction with the two ends of each of the motor touch switch lever, the sucking disc touch switch lever of the end framework and the sucking disc touch switch lever of the middle framework is arranged on the end framework sucking disc arm; and a motor which is electrically connected to the motor, the vacuum generators, the motor touch switch lever, the sucking disc touch switch lever of the end framework, the sucking disc touch switch lever of the middle framework, the contact point and the liquid spray pump is arranged on the middle framework sucking disc arm.

Preferably, the rear ends of the connecting rods of the wiping brush and the cleaning brush are fixedly arranged on the same pressure plate, the position, beside the pressure plate, of the middle framework sucking disc arm is fixedly equipped with a spring mounting cavity, the cavity opening of which faces towards the pressure plate; the pressure plate is embedded into the spring mounting cavity and is connected to the inner cavity bottom of the spring mounting cavity through a spring; the shape of the pressure plate is adaptive to that of the spring mounting cavity, so that the pressure plate is compressed in the spring mounting cavity and is guided horizontally.

A cleaning method of the self-cleaning device for highway tunnel retro-reflective arch includes the following steps that: in use, adsorption force is generated when a sucking disc of the end framework sucking disc arm and a sucking disc of the middle framework sucking disc arm are different, i.e., when the sucking disc of the end framework sucking disc arm is adsorbed, the sucking disc of the middle framework sucking disc arm does not work, and the middle framework sucking disc arm moves relative to the end framework sucking disc arm under drive of an electric mechanism, and clings to the wiping brush and the cleaning rush on the retro-reflective arch wall to wipe during movement; while the middle framework sucking disc arm moves to a limited position, the sucking disc of the middle framework sucking disc arm is adsorbed to stop wiping, the sucking disc of the end framework sucking disc arm does not work, and the end framework sucking disc arm is driven by the electric mechanism to move towards the middle framework sucking disc arm; when the end framework sucking disc arm moves to the limited position in the same direction of the middle framework sucking disc arm, the sucking disc of the end framework sucking disc arm is adsorbed, the sucking disc of the middle framework sucking disc arm does not work, and the middle framework sucking disc continuously moves relative to the end framework sucking disc arm under drive of the electric mechanism, and clings to the wiping brush and the cleaning brush on the retro-reflective arch wall to wipe during movement, thereby realizing self-walking wiping in a reciprocating mode.

Preferably, in the above steps: (1) during adsorption, the upper sucking disc is adsorbed on the top wall of the tunnel while the lower sucking disc is adsorbed on the side wall of the retro-reflective arch; (2) when the sucking disc of the end framework sucking disc arm is adsorbed, the sucking disc of the middle framework sucking disc arm does not work and the middle framework sucking disc arm is driven by the electric mechanism to move relative to the end framework sucking disc arm; if the motor rotates forwards, the sucking disc of the middle framework sucking disc arm is adsorbed, the sucking disc of the end framework sucking disc arm does not work when the middle framework sucking disc arm moves to the limited position; and the motor reversely rotates when the end framework sucking disc is driven by the electric mechanism to move in the same direction with the middle framework sucking disc arm; (3) when the middle framework sucking disc arm moves to the limited position, one end of the motor touch switch lever, one end of the sucking disc touch switch lever of the end framework and one end of the sucking disc touch switch lever of the middle framework are in touch with a contact point on the end framework sucking disc arm at the same side, so that the motor is changed into reverse rotation from forward rotation, the sucking disc of the middle framework is adsorbed and the sucking disc of the end framework is not adsorbed; while the end framework sucking disc arm moves to the limited position in the same direction with the middle framework sucking disc arm, the other end of the motor touch switch lever, the other end of the sucking disc touch switch lever of the end framework and the other end of the sucking disc touch switch lever of the middle framework are in touch with a contact point on the end framework sucking disc arm at another same side, so that the motor is changed into forward rotation from reverse rotation, the sucking disc of the middle framework is not adsorbed and the sucking disc of the end framework is adsorbed in a circulating mode; and (4), when the top wall of the tunnel and the retro-reflective arch are arc-shaped, through the first rotary shaft, the torsion spring and the second rotary shaft, self-rotation is realized as follows: only one of the end framework sucking disc arm and the middle framework sucking disc frame is in an adsorption state and the other one is in a movable state; when the end framework sucking disc arm is fixed and the middle framework sucking disc arm moves, the middle framework sucking disc arm is in contact with the top wall of the tunnel in a sucking disc moving process, so that the middle framework sucking disc arm achieves self-rotation along the first rotary shaft and the second rotary shaft to adapt to radian change of the tunnel wall, and the torsion spring twists to store force; while the middle framework sucking disc arm is fixed and the end framework sucking disc arm moves, the torsion spring returns and the end framework sucking disc is twisted by the torsion spring in the moving process, so that the end framework sucking disc arm is twisted to the same swing position of the middle framework sucking disc arm to adapt to the radian change of the tunnel wall in a circulating mode.

Compared with the prior art, the invention has the following beneficial effects: The self-cleaning device for highway tunnel retro-reflective arch is simple in structure; in use, adsorption force is generated when the sucking disc of the end framework sucking disc arm and the sucking disc of the middle framework sucking disc arm are different, i.e., when the sucking disc of the end framework sucking disc arm is adsorbed, the sucking disc of the middle framework sucking disc arm does not work, and the middle framework sucking disc arm moves relative to the end framework sucking disc arm under drive of the electric mechanism, and clings to the wiping brush and the cleaning rush on the retro-reflective arch wall to wipe during movement; while the middle framework sucking disc arm moves to a limited position, the sucking disc of the middle framework sucking disc arm is adsorbed to stop wiping, the sucking disc of the end framework sucking disc arm does not work, and the end framework sucking disc arm is driven by the electric mechanism to move towards the middle framework sucking disc arm; when the end framework sucking disc arm moves to the limited position in the same direction of the middle framework sucking disc arm, the sucking disc of the end framework sucking disc arm is adsorbed, the sucking disc of the middle framework sucking disc arm does not work, and the middle framework sucking disc continuously moves relative to the end framework sucking disc arm under drive of the electric mechanism, and clings to the wiping brush and the cleaning brush on the retro-reflective arch wall to wipe during movement, thereby realizing self-walking wiping in a reciprocating mode.

The invention will be further described in detail below with reference to the drawings and specific embodiments.

### BRIEF DESCRIPTION OF THE FIGURES

FIG. 1 is a bottom view of an embodiment of the invention.

FIG. 2 is a side view of an embodiment of the invention.

FIG. 3 is a side view of an electric mechanism.

FIG. 4 is a schematic diagram I of the principle of self-walking.

FIG. 5 is a schematic diagram II of the principle of self-walking.

FIG. 6 is a schematic diagram III of the principle of self-walking.

FIG. 7 is a schematic diagram IV of the principle of self-walking.

FIG. 8 is a schematic diagram showing the structure of the wiping brush and the cleaning brush.

### DETAILED DESCRIPTION OF THE PREFERRED EMBODIMENTS

In order to make the above-mentioned features and advantages of the invention more obvious and understandable, the embodiments are described below in conjunction with the drawings, which are described in detail below.

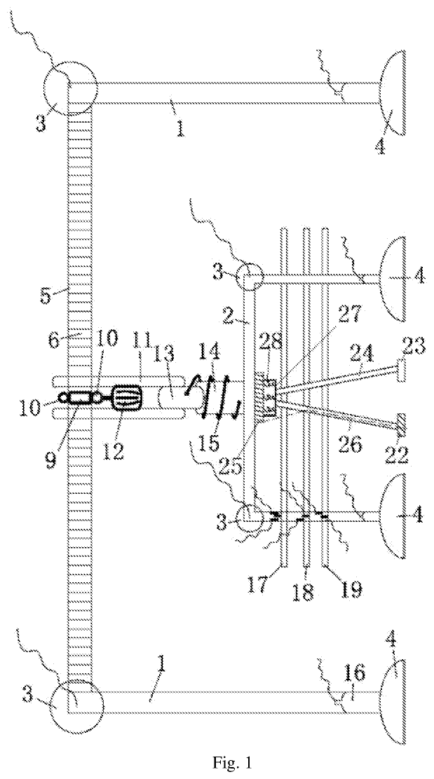

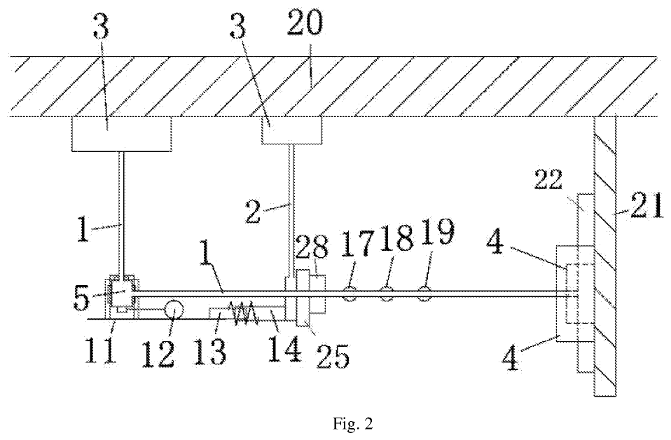

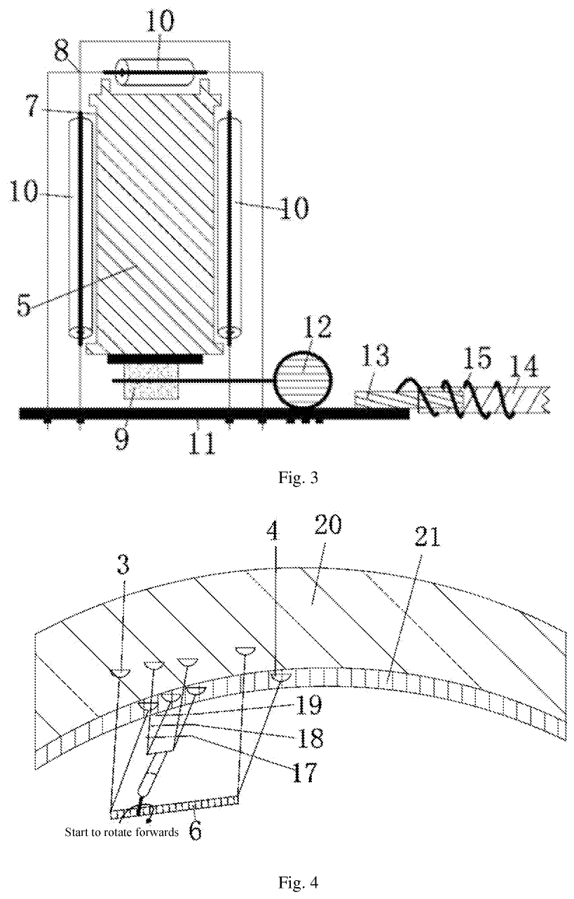

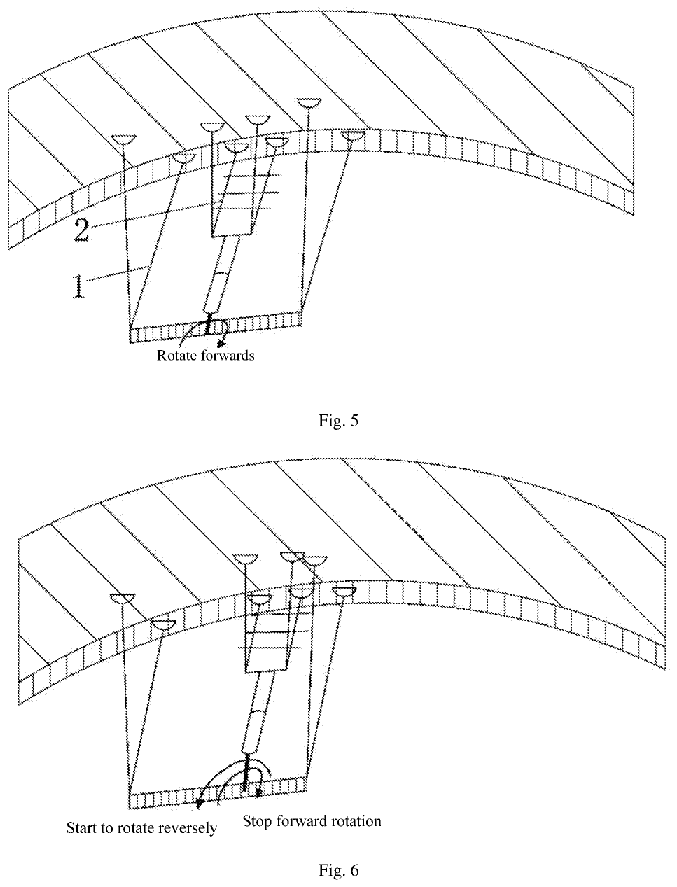

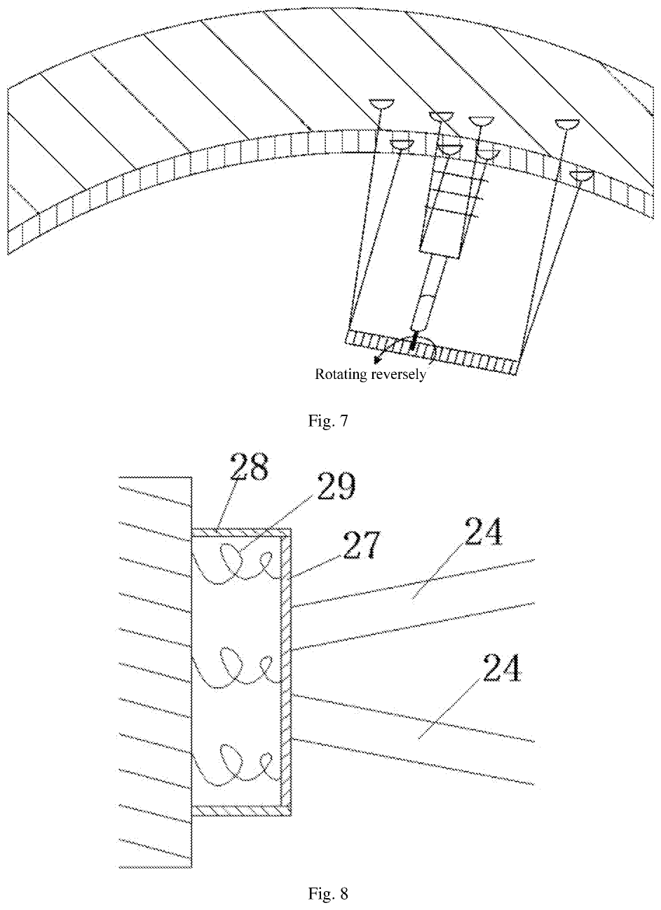

As shown in FIG. 1 to FIG. 8, a self-cleaning device for a highway tunnel retro-reflective arch includes an end framework sucking disc arm 1, where a middle framework sucking disc arm 2 is arranged in the end framework sucking disc arm; upper sucking discs 3 used for adsorbing the top wall of the tunnel upwards and lower sucking discs 4 used for adsorbing the side wall of the retro-reflective arch forwards or backwards are separately arranged on the end framework sucking disc arm and the middle framework sucking disc arm; the end framework sucking disc arm and the middle framework sucking disc arm are driven by an electric mechanism to relatively move in the width direction of the tunnel;

a wiping brush 23 and a cleaning brush 22 are arranged on the side of the lower sucking disc of the middle framework sucking disc arm in sequence in the moving direction, and the wiping brush and the cleaning brush are connected to the middle framework sucking disc arm through connecting rods 24; a cleaning liquid box 25 is arranged on the middle framework sucking disc arm and is in communication through a cleaning liquid tube 26 to spray liquid to the cleaning brush, and a liquid spray pump is arranged in the cleaning liquid box. The liquid spray pump is used for spraying cleaning liquid to the cleaning brush to clean, and the cleaning brush firstly brushes and then the wiping brush wipes.

In the embodiment of the invention, the electric mechanism includes a main gear girder 5 which is fixedly arranged on the end framework sucking disc arm and extends in the width direction of tunnel, where the lower side surface of the main gear girder is provided with a rack 6 and the other three side surfaces are provided with wheel slots 7.

In the embodiment of the invention, a fixed auxiliary frame 8 sleeves the periphery of the main gear girder, the lower side part of the fixed auxiliary frame is equipped with a gear 9 engaged with the rack, and the other three side parts are equipped with pressure wheels 10 which are embedded into the corresponding wheel slots to roll.

In the embodiment of the invention, a fixed main frame 11 is fixedly connected below the fixed auxiliary frame, a motor 12 with an output shaft connected to a gear is mounted on the fixed main frame, and the fixed main frame is connected to the middle framework sucking disc arm.

In the embodiment of the invention, the top of the tunnel and the retro-reflective arch are arc-shaped.

In the embodiment of the invention, a first rotary shaft 13 extending in the horizontal direction is fixedly arranged on the fixed main frame, the middle part of the middle framework sucking disc arm is fixedly equipped with a second rotary shaft 14 extending in the horizontal direction, and the first rotary shaft is coaxially inserted into the second rotary shaft to relatively rotate.

In the embodiment of the invention, a torsion spring 15 coaxially sleeves the peripheral part of the first rotary shaft and the peripheral part of the second rotary shaft, one end of the torsion spring is fixed to the first rotary shaft and the other end of the torsion spring is fixed to the second rotary shaft.

In the embodiment of the invention, vacuum generators 16 are connected on the upper sucking disc and the lower sucking disc, an equal-length motor touch switch lever 17, a sucking disc touch switch lever 18 of an end framework and a sucking disc touch switch lever 19 of a middle framework, which extend in the width direction of the tunnel, are arranged on the end framework sucking disc arm; the two ends of the end framework sucking disc arm are used for touching the end framework sucking disc arm while the end framework sucking disc arm and the middle framework sucking disc arm relatively move; a contact point which is in touch conduction with the two ends of each of the motor touch switch lever, the sucking disc touch switch lever of the end framework and the sucking disc touch switch lever of the middle framework is arranged on the end framework sucking disc arm; and a motor which is electrically connected to the motor, the vacuum generators, the motor touch switch lever, the sucking disc touch switch lever of the end framework, the sucking disc touch switch lever of the middle framework, the contact point and the liquid spray pump is arranged on the middle framework sucking disc arm.

In the embodiment of the invention, the rear ends of the connecting rods of the wiping brush and the cleaning brush are fixedly arranged on the same pressure plate 27, the position, beside the pressure plate, of the middle framework sucking disc arm is fixedly equipped with a spring mounting cavity 28, the cavity opening of which faces towards the pressure plate; the pressure plate is embedded into the spring mounting cavity and is connected to the inner cavity bottom of the spring mounting cavity through a spring 29; the shape of the pressure plate is adaptive to that of the spring mounting cavity, so that the pressure plate is compressed in the spring mounting cavity and is guided horizontally.

In the embodiment of the invention, the wiping brush with the spring and the cleaning brush with the spring are integrated on a self-walking base, so that the wiping brush and the cleaning brush can cling to the side wall of the retro-reflective arch to improve wiping effect; and the end parts of the springs are fixedly connected to the pressure plate and the inner cavity bottom of the spring mounting cavity.

A cleaning method of the self-cleaning device for a highway tunnel retro-reflective arch includes the following steps that: in use, adsorption force is generated when a sucking disc of the end framework sucking disc arm and a sucking disc of the middle framework sucking disc arm are different, i.e., when the sucking disc of the end framework sucking disc arm is adsorbed, the sucking disc of the middle framework sucking disc arm does not work, and the middle framework sucking disc arm moves relative to the end framework sucking disc arm under drive of an electric mechanism, and clings to the wiping brush and the cleaning rush on the retro-reflective arch wall to wipe during movement; while the middle framework sucking disc arm moves to a limited position, the sucking disc of the middle framework sucking disc arm is adsorbed to stop wiping, the sucking disc of the end framework sucking disc arm does not work, and the end framework sucking disc arm is driven by the electric mechanism to move towards the middle framework sucking disc arm; when the end framework sucking disc arm moves to the limited position in the same direction of the middle framework sucking disc arm, the sucking disc of the end framework sucking disc arm is adsorbed, the sucking disc of the middle framework sucking disc arm does not work, and the middle framework sucking disc continuously moves relative to the end framework sucking disc arm under drive of the electric mechanism, and clings to the wiping brush and the cleaning brush on the retro-reflective arch wall to wipe during movement, thereby realizing self-walking wiping in a reciprocating mode.

Preferably, in the above steps: (1) during adsorption, the upper sucking disc is adsorbed on the top wall of the tunnel 20 while the lower sucking disc is adsorbed on the side wall of the retro-reflective arch 21; (2) when the sucking disc of the end framework sucking disc arm is adsorbed, the sucking disc of the middle framework sucking disc arm does not work and the middle framework sucking disc arm is driven by the electric mechanism to move relative to the end framework sucking disc arm; if the motor rotates forwards, the sucking disc of the middle framework sucking disc arm is adsorbed, the sucking disc of the end framework sucking disc arm does not work when the middle framework sucking disc arm moves to the limited position; and the motor reversely rotates when the end framework sucking disc is driven by the electric mechanism to move in the same direction with the middle framework sucking disc arm; (3) when the middle framework sucking disc arm moves to the limited position, one end of the motor touch switch lever, one end of the sucking disc touch switch lever of the end framework and one end of the sucking disc touch switch lever of the middle framework are in touch with a contact point on the end framework sucking disc arm at the same side, so that the motor is changed into reverse rotation from forward rotation, the sucking disc of the middle framework is adsorbed and the sucking disc of the end framework is not adsorbed; while the end framework sucking disc arm moves to the limited position in the same direction with the middle framework sucking disc arm, the other end of the motor touch switch lever, the other end of the sucking disc touch switch lever of the end framework and the other end of the sucking disc touch switch lever of the middle framework are in touch with a contact point on the end framework sucking disc arm at another same side, so that the motor is changed into forward rotation from reverse rotation, the sucking disc of the middle framework is not adsorbed and the sucking disc of the end framework is adsorbed in a circulating mode; and (4), when the top wall of the tunnel and the retro-reflective arch are arc-shaped, through the first rotary shaft, the torsion spring and the second rotary shaft, self-rotation is realized as follows: only one of the end framework sucking disc arm and the middle framework sucking disc frame is in an adsorption state and the other one is in a movable state; when the end framework sucking disc arm is fixed and the middle framework sucking disc arm moves, the middle framework sucking disc arm is in contact with the top wall of the tunnel in a sucking disc moving process, so that the middle framework sucking disc arm achieves self-rotation along the first rotary shaft and the second rotary shaft to adapt to radian change of the tunnel wall, and the torsion spring twists to store force; while the middle framework sucking disc arm is fixed and the end framework sucking disc arm moves, the torsion spring returns and the end framework sucking disc is twisted by the torsion spring in the moving process, so that the end framework sucking disc arm is twisted to the same swing position of the middle framework sucking disc arm to adapt to the radian change of the tunnel wall in a circulating mode.

The invention is not limited to the above-mentioned best embodiment, anyone can obtain other various forms of self-cleaning devices for highway tunnel retro-reflective arches and cleaning methods of the self-cleaning devices under the inspiration of the invention. All equivalent changes and modifications made in accordance with the scope of the invention patent application shall fall within the scope of the invention.

What is claimed is:

1. A self-cleaning device for a highway tunnel retro-reflective arch, comprising an end framework sucking disc arm, wherein a middle framework sucking disc arm is arranged in the end framework sucking disc arm; upper sucking discs used for adsorbing the top wall of the tunnel upwards and lower sucking discs used for adsorbing the side wall of the retro-reflective arch forwards or backwards are separately arranged on the end framework sucking disc arm and the middle framework sucking disc arm; the end framework sucking disc arm and the middle framework sucking disc arm are driven by an electric mechanism to relatively move in the width direction of the tunnel; a wiping brush and a cleaning brush are arranged on the side of the lower sucking disc of the middle framework sucking disc arm in sequence in the moving direction, and the wiping brush and the cleaning brush are connected to the middle framework sucking disc arm through connecting rods; and a cleaning liquid box is arranged on the middle framework sucking disc arm and is in communication through a cleaning liquid tube to spray liquid to the cleaning brush, and a liquid spray pump is arranged in the cleaning liquid box.

2. The self-cleaning device for the highway tunnel retro-reflective arch according to claim 1, wherein the electric mechanism comprises a main gear girder which is fixedly arranged on the end framework sucking disc arm and extends in the width direction of tunnel, the lower side surface of the main gear girder is provided with a rack and the other three side surfaces are provided with wheel slots.

3. The self-cleaning device for the highway tunnel retro-reflective arch according to claim 2, wherein a fixed auxiliary frame sleeves the periphery of the main gear girder, the lower side part of the fixed auxiliary frame is equipped with a gear engaged with the rack, and the other three side parts are equipped with pressure wheels which are embedded into the corresponding wheel slots to roll.

4. The self-cleaning device for the highway tunnel retro-reflective arch according to claim 3, wherein a fixed main frame is fixedly connected below the fixed auxiliary frame, a motor with an output shaft connected to a gear is mounted on the fixed main frame, and the fixed main frame is connected to the middle framework sucking disc arm.

5. The self-cleaning device for the highway tunnel retro-reflective arch according to claim 4, wherein the top of the tunnel and the retro-reflective arch are arc-shaped.

6. The self-cleaning device for the highway tunnel retro-reflective arch according to claim 5, wherein a first rotary shaft extending in the horizontal direction is fixedly arranged on the fixed main frame, the middle part of the middle framework sucking disc arm is fixedly equipped with a second rotary shaft extending in the horizontal direction, and the first rotary shaft is coaxially inserted into the second rotary shaft to relatively rotate.

7. The self-cleaning device for the highway tunnel retro-reflective arch according to claim 6, wherein a torsion spring coaxially sleeves the peripheral part of the first rotary shaft and the peripheral part of the second rotary shaft, one end of the torsion spring is fixed to the first rotary shaft and the other end of the torsion spring is fixed to the second rotary shaft; vacuum generators are connected on the upper sucking disc and the lower sucking disc, an equal-length motor touch switch lever, a sucking disc touch switch lever of an end framework and a sucking disc touch switch lever of a middle framework, which extend in the width direction of the tunnel, are arranged on the end framework sucking disc arm; the two ends of the end framework sucking disc arm are used for touching the end framework sucking disc arm while the end framework sucking disc arm and the middle framework sucking disc arm relatively move; a contact point which is in touch conduction with the two ends of each of the motor touch switch lever, the sucking disc touch switch lever of the end framework and the sucking disc touch switch lever of the middle framework is arranged on the end framework sucking disc arm; and a motor which is electrically connected to the motor, the vacuum generators, the motor touch switch lever, the sucking disc touch switch lever of the end framework, the sucking disc touch switch lever of the middle framework, the contact point and the liquid spray pump is arranged on the middle framework sucking disc arm.

8. The self-cleaning device for the highway tunnel retro-reflective arch according to claim 1, wherein the rear ends of the connecting rods of the wiping brush and the cleaning brush are fixedly arranged on the same pressure plate, the position, beside the pressure plate, of the middle framework sucking disc arm is fixedly equipped with a spring mounting cavity, the cavity opening of which faces towards the pressure plate; the pressure plate is embedded into the spring mounting cavity and is connected to the inner cavity bottom of the spring mounting cavity through a spring; and the shape of the pressure plate is adaptive to that of the spring mounting cavity, so that the pressure plate is compressed in the spring mounting cavity and is guided horizontally.

9. A cleaning method of the self-cleaning device for the highway tunnel retro-reflective arch according to any one of claim 1, comprising the following steps that: in use, adsorption force is generated when a sucking disc of the end framework sucking disc arm and a sucking disc of the middle framework sucking disc arm are different, i.e., when the sucking disc of the end framework sucking disc arm is adsorbed, the sucking disc of the middle framework sucking disc arm does not work, and the middle framework sucking disc arm moves relative to the end framework sucking disc arm under drive of an electric mechanism, and clings to the wiping brush and the cleaning rush on the retro-reflective arch wall to wipe during movement; while the middle framework sucking disc arm moves to a limited position, the sucking disc of the middle framework sucking disc arm is adsorbed to stop wiping, the sucking disc of the end framework sucking disc arm does not work, and the end framework sucking disc arm is driven by the electric mechanism to move towards the middle framework sucking disc arm; when the end framework sucking disc arm moves to the limited position in the same direction of the middle framework sucking disc arm, the sucking disc of the end framework sucking disc arm is adsorbed, the sucking disc of the middle framework sucking disc arm does not work, and the middle framework sucking disc continuously moves relative to the end framework sucking disc arm under drive of the electric mechanism, and clings to the wiping brush and the cleaning brush on the retro-reflective arch wall to wipe during movement, thereby realizing self-walking wiping in a reciprocating mode.

10. The cleaning method of the self-cleaning device for the highway tunnel retro-reflective arch according to claim 9, wherein in the above steps: (1) during adsorption, the upper sucking disc is adsorbed on the top wall of the tunnel while the lower sucking disc is adsorbed on the side wall of the retro-reflective arch; (2) when the sucking disc of the end framework sucking disc arm is adsorbed, the sucking disc of the middle framework sucking disc arm does not work and the middle framework sucking disc arm is driven by the electric mechanism to move relative to the end framework sucking disc arm; if the motor rotates forwards, the sucking disc of the middle framework sucking disc arm is adsorbed, the sucking disc of the end framework sucking disc arm does not work when the middle framework sucking disc arm moves to the limited position; and the motor reversely rotates when the end framework sucking disc is driven by the electric mechanism to move in the same direction with the middle framework sucking disc arm; (3) when the middle framework sucking disc arm moves to the limited position, one end of the motor touch switch lever, one end of the sucking disc touch switch lever of the end framework and one end of the sucking disc touch switch lever of the middle framework are in touch with a contact point on the end framework sucking disc arm at the same side, so that the motor is changed into reverse rotation from forward rotation, the sucking disc of the middle framework is adsorbed and the sucking disc of the end framework is not adsorbed; while the end framework sucking disc arm moves to the limited position in the same direction with the middle framework sucking disc arm, the other end of the motor touch switch lever, the other end of the sucking disc touch switch lever of the end framework and the other end of the sucking disc touch switch lever of the middle framework are in touch with a contact point on the end framework sucking disc arm at another same side, so that the motor is changed into forward rotation from reverse rotation, the sucking disc of the middle framework is not adsorbed and the sucking disc of the end framework is adsorbed in a circulating mode; and (4), when the top wall of the tunnel and the retro-reflective arch are arc-shaped, through the first rotary shaft, the torsion spring and the second rotary shaft, self-rotation is realized as follows: only one of the end framework sucking disc arm and the middle framework sucking disc frame is in an adsorption state and the other one is in a movable state; when the end framework sucking disc arm is fixed and the middle framework sucking disc arm moves, the middle framework sucking disc arm is in contact with the top wall of the tunnel in a sucking disc moving process, so that the middle framework sucking disc arm achieves self-rotation along the first rotary shaft and the second rotary shaft to adapt to radian change of the tunnel wall, and the torsion spring twists to store force; while the middle framework sucking disc arm is fixed and the end framework sucking disc arm moves, the torsion spring returns and the end framework sucking disc is twisted by the torsion spring in the moving process, so that the end framework sucking disc arm is twisted to the same swing position of the middle framework sucking disc arm to adapt to the radian change of the tunnel wall in a circulating mode.
